(19) United States
(12) Patent Application Publication
(10) Pub. No.: US 2006/0019635 A1
(43) Pub. Date: Jan. 26, 2006

(54) Enhanced use of a network access identifier in wlan

(75) Inventors: Juha Ollila, Oulu (FI); Henry Haverinen, Jyvaskyla (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/154,668

(22) Filed: Jun. 17, 2005

Related U.S. Application Data
(60) Provisional application No. 60/583,355, filed on Jun. 29, 2004.

(51) Int. Cl. H04M 1/68; H04M 1/66

(52) U.S. Cl. 455/411; 455/410; 455/435.1; 455/552.1

(57) ABSTRACT

A network including a user equipment for accessing at least one of wireless local area network interworking services and third generation partnership project network services. The network also includes at least one third generation partnership project network for providing the third generation partnership project network services to the user equipment. The network further includes an access network for connecting the user equipment to the third generation partnership project network and for providing the wireless local area network interworking services. During network authentication, the user equipment provides a network access identifier including wireless local area network scenario information and an impostor is prevented from modifying the network access identifier during a response from the user equipment to the at least one third generation partnership project network implementing an authentication mechanism.

### BACKGROUND OF THE INVENTION

1. Field of the Invention

The present invention relates to a method of accessing 3GPP networks and particularly to a method of accessing 3GPP networks using a wireless local area network and an enhanced network access identifier.

2. Description of the Related Art

A wireless local area network (WLAN) is made up of different radio technologies, all of which are commonly used for transportation of IP datagrams. WLAN can be used as an alternative access method to 3^{rd} Generation Partnership Project (3GPP) networks. A 3GPP network is typically an evolved Global System for Mobile Communications (GSM) core network infrastructure. The WLAN access method provides network access security to 3GPP networks that is as good as GSM and Universal Mobile Telecommunication System (UMTS) access methods. A 3GPP network access ensures network security by providing user identity confidentiality, user authentication, network authentication, confidentiality of data and integrity of data. In order to maintain the network security provided by the 3GPP network, WLAN network access security is based on Extensible Authentication Protocol (EAP), EAP-SIM, EAP-AKA, Encapsulating Security Protocol (ESP) and Internet Key Exchange (IKEv2).

Currently a WLAN user equipment may connect to a 3GPP home network or a 3GPP visited network through a WLAN access point. During these connections, authentication signalling for 3GPP-WLAN interworking is based on EAP. The user equipment connected to a 3GPP network and an Authentication Authorisation Accounting (AAA) server in the 3GPP network supports both EAP-AKA and EAP-SIM protocols. The EAP-SIM and EAP-AKA protocols are used in WLAN-3GPP interworking as authentication and key agreement protocols.

When the user equipment is connected to a 3GPP visited network, the 3GPP home network is responsible for access control. In some cases the 3GPP home network may also be responsible for tunnel establishment. Alternatively, the authorization decision of tunnel establishment may be taken up by a 3GPP proxy AAA server in the 3GPP visited network. The user equipment and a packet data gateway in the 3GPP visited network use IKEv2 to establish IPSec security associations whereby a public key signature based authentication with certificates is used to authenticate the packet data gateway and EAP-AKA or EAP-SIM within IKEv2 is used to authenticate the user equipment.

When EAP-AKA or EAP-SIM within IKEv2 is used to authenticate the user equipment, an EAP session key which is the MSK from EAP-AKA and EAP-SIM is delivered from the EAP AAA server to the either the WLAN access point or the packet data gateway, depending on whether the home network or the visited network is responsible for access control. Thereafter, AUTH payload in IKEv2 is computed from the MSK. However, an impostor WLAN access point may impersonate a valid WLAN access point, obtain the MSK, consequently compute the AUTH payload and impersonate the WLAN or the packet data gateway toward the user equipment. An impostor packet data gateway, in the 3GPP visited network, with the computed AUTH may further impersonate a valid packet data gateway in a home network.

To prevent such man-in-the-middle/impostor attacks, public key signatures based authentication with certificates may be used. The certificate may be verified with a root key which is only used to sign certificates of packet data gateways of the home operator. Therefore, the user equipment knows that it is setting up an IPsec tunnel to the home operator and not to an impostor in control of a WLAN access point. However, the use of public key certificates is a rather complex solution because certificates require at least minimal public key infrastructure (PKI). The minimal PKI would contain the certificate authority (CA), manual certificate handling and a mechanism to check the status of certificate (e.g., LDAP and certificate revocation lists).

Alternatively, EAP-SIM or EAP-AKA could be enhanced to securely carry context information between the user equipment and the EAP AAA server. The context information ensures that a WLAN access point or a packet data gateway in a 3GPP visited network cannot present two different contexts, one to the user equipment and another to the EAP AAA server. Specifically, a special RAND mechanism is extended to separate those scenarios where the 3GPP home network is responsible for tunnel establishment from those scenarios where the 3GPP proxy AAA server in the 3GPP visited network is responsible for tunnel establishment authorization decision. The WLAN scenario information is then bound to a special RAND value. This is also a complex solution in that the special RAND is required to include encryption algorithms restriction vector context field that can be used to indicate the WLAN scenario.

### SUMMARY OF THE INVENTION

According to one aspect of the invention, there is provided a user equipment for accessing at least one of wireless local area network interworking services and third generation partnership project network services. The user equipment includes receiving means for receiving third generation partnership project network services from at least one third generation partnership project network and for receiving wireless local area network interworking services from an access network that connects the user equipment to the third generation partnership project network. The user equipment also includes generating means for generating, during network authentication, a network access identifier including wireless local area network scenario information. An impostor is prevented from modifying the network access identifier during a response from the user equipment to the at least one third generation partnership project network implementing an authentication mechanism.network.

According to another aspect of the invention, there is provided a server for using a network access identifier to identify a user equipment during network authentication between the user equipment and a third generation partnership project network. The server includes receiving means for receiving the network access identifier from the user equipment; and requesting means for requesting the network access identifier using an authentication mechanism. The network access identifier includes at least one field for identifying a wireless local area network scenario and at least one field for identifying a home network. The at least one field for identifying a home network comprises a mobile country code and a mobile network code associated with the home network. By requesting the network access identifier in an authentication mechanism an impostor is prevented from modifying the network access identifier during a response from the user equipment to the at least one third generation partnership project network implementing the authentication mechanism.

According to another aspect of the invention, there is provided a server for using a network access identifier to identify a user equipment during network authentication between the user equipment and a third generation partnership project network. The server includes receiving means for receiving the network access identifier from the user equipment and requesting means for requesting the network access identifier using an authentication mechanism. The network access identifier includes at least one field for identifying a wireless local area network scenario, at least one field for identifying a home network, the at least one field for identifying a home network comprises a mobile country code and a mobile network code associated with the home and at least one field for identifying a home network, the at least one field for identifying a home network including a mobile country code and a mobile network code associated with the home. By requesting the network access identifier in an authentication mechanism an impostor is prevented from modifying the network access identifier during a response from the user equipment to the at least one third generation partnership project network implementing the authentication mechanism.

According to another aspect of the invention, there is provided a method for identifying a user equipment during network authentication between the user equipment and a third generation partnership project network. The method includes the steps of establishing a connection between the user equipment and a wireless local area network access point and providing a user equipment identity, by the user equipment. The user equipment identity includes a network access identifier having at least one field for identifying a wireless local area network scenario. The method further includes the steps of receiving, by the user equipment, a request for the user equipment identity with an authentication mechanism request message and resubmitting, by the user equipment, the network access identifier in an authentication mechanism response message, whereby an impostor unable to modify the resubmitted network access identifier in the authentication mechanism response message.

According to another aspect of the invention, there is provided an apparatus for identifying a user equipment during network authentication between the user equipment and a third generation partnership project network. The apparatus includes establishing means for establishing a connection between the user equipment and the third generation partnership project network through a wireless local area network access point. The apparatus also include providing means for providing a user equipment identity, by the user equipment, wherein the user equipment identity comprises a network access identifier having at least one field for identifying a wireless local area network scenario. The apparatus further includes receiving means for receiving a request for the user equipment identity with an authentication mechanism request message and means for resubmitting, by the user equipment, the network access identifier in an authentication mechanism response message, wherein an impostor unable to modify the resubmitted network access identifier in the authentication mechanism response message.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1a illustrates a current embodiment of a non-roaming 3GPP-WLAN system;

FIG. 1b illustrates an embodiment of roaming 3GPP-WLAN systems wherein the home network is responsible for both access control and tunnel establishment;

FIG. 1c illustrates an embodiment of roaming 3GPP-WLAN systems wherein the visited network is responsible for tunnel establishment;

FIG. 2 illustrates the steps implemented to use the EAP-AKA authentication mechanism in WLAN-3GPP interworking; and

FIG. 3 illustrates the steps implemented to use the EAP-SIM authentication mechanism in WLAN-3GPP interworking.

### DETAILED DESCRIPTION OF THE INVENTION

Reference will now be made to the preferred embodiments of the present invention, examples of which are illustrated in the accompanying drawings.

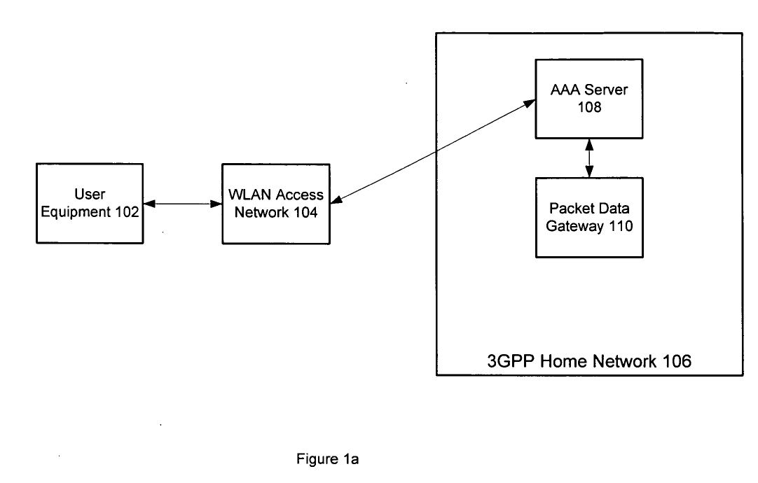

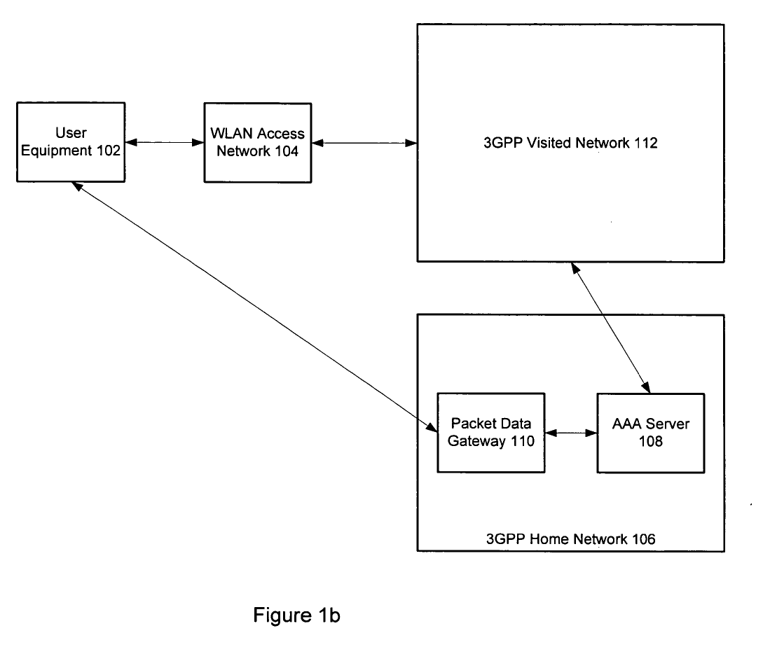

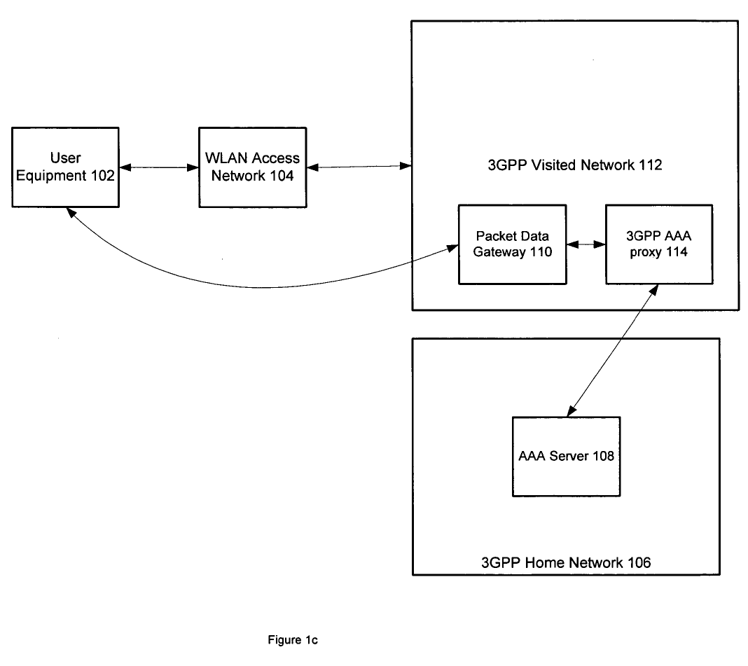

FIG. 1a illustrates one embodiment of a non-roaming 3GPP-WLAN system. WLAN user equipment 102, such as a laptop computer or PDA with a WLAN card and suitable hardware and software applications, is equipped with a UICC, USIM or SIM card for accessing WLAN interworking service and is connected to 3GPP Home Network 106 through WLAN access network 104. Home network 106 includes an Authentication Authorization Accounting (AAA) server 108 for retrieving authentication information, authenticating a subscriber on user equipment 102 based on the authentication information and communicating authorization information to WLAN access network 104. Home network 106 also includes a packet data gateway 110 for enforcing tunnel authorization and establishment with the information received from AAA server 108. User equipment 102 may be capable of WLAN and/or 3GPP system access. As is apparent to those skilled in the art, user equipment 102 may be functionally split over several physical devices that communicate over local interfaces.

FIGS. 1b and 1c illustrate embodiments of roaming 3GPP-WLAN systems which include a visited 3GPP network 112. In FIG. 1b, packet data gateway 110 is located in home network 106 and home network 106 is responsible for both access control and tunnel establishment. In FIG. 1c, packet data gateway 110 is located in visited network 112 and authorization decisions of tunnel establishment is provided by proxy AAA server 114 based on information in server 114 and information retrieved from home network 106.

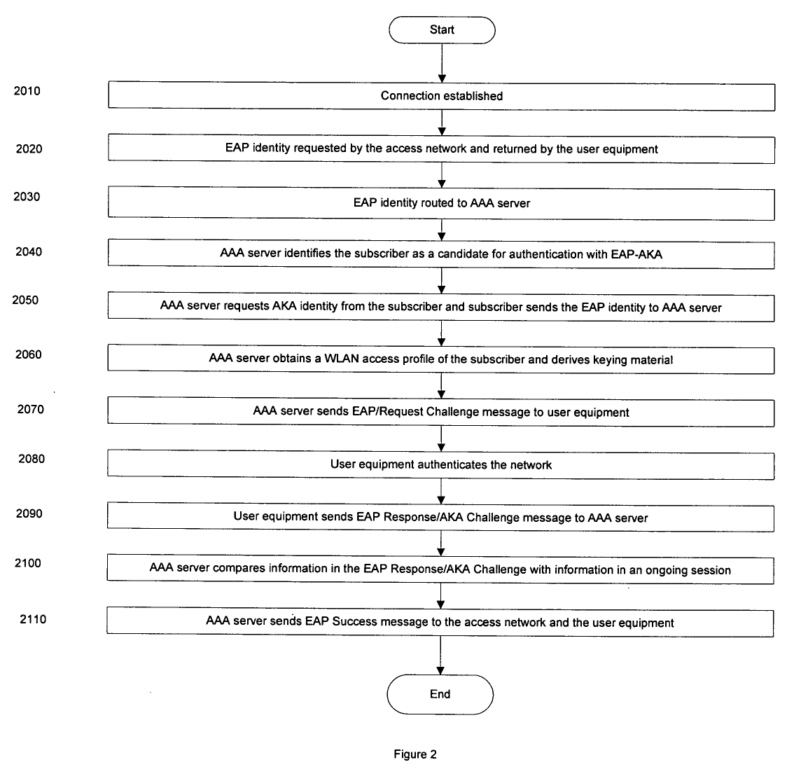

FIG. 2 illustrates the steps implemented to use the EAP-AKA authentication mechanism in WLAN-3GPP interworking. In Step 2010, a connection is established between user equipment 102 and access network 104, using a wireless LAN technology. In Step 2020, access network 104 sends an EAP Request/Identity to user equipment 102 and user equipment 102 sends an EAP Response/Identity message with an identity of user equipment 102 to access network 104. The identity complies with the network access identifier (NAI) format and includes either a temporary identifier allocated to user equipment 102 in a previous authentication, or in a case of a first authentication with the network, the IMSI. In Step 2030, the message is routed towards the proper AAA server based on a realm part of the NAI. The routing path may include one or several AAA proxies. In Step 2040, AAA server 108 receives the EAP Response/Identity packet that includes the subscriber identity and the identifier of the WLAN network, among other information, and identifies the subscriber as a candidate for authentication with EAP-AKA, based on the received identity.

In Step 2050, AAA server 108 requests the user identity using a EAP Request/AKA Identity message and user equipment responds with the same identity it used in the EAP Response/Identity message. Access network 104 forwards the EAP Response/AKA Identity message to AAA server 108 for use by AAA server 108 in the authentication process. In Step 2060, AAA server 108 obtains the WLAN access profile of the subscriber and verifies that the subscriber is authorized to use the WLAN service. AAA server 108 also derives keying material required by EAP-AKA and a new pseudonym may be chosen and protected using EAP-AKA generated keying material. In Step 2070, AAA server 108 sends RAND, AUTH, a message authentication code (MAC) and the user identities (protected pseudonym and/or re-authentication ID), if generated, to user equipment 102 in a EAP Request/AKA Challenge message. User equipment 102 runs UMTS algorithm on the USIM to verify that AUTN is correct and thereby authenticate the network in Step 2080. In Step 2090, if AUTH is incorrect, user equipment rejects the authentication, or else, user equipment derives additional keying material, checks the MAC with the newly derived keying material, stores the received pseudonym for future authentication, calculates a new MAC value covering the EAP message with the new keying material and sends the EAP Response/AKA-Challenge containing the newly calculated MAC value to AAA server 108. In Step 2100, AAA server 108 checks and compares the received information with the same information of the ongoing session and if the information is the same as the ongoing session, AAA server determines that the authentication exchange is related to the ongoing session. In Step 2110, AAA server 108 then sends an EAP Success message and additional keying material to access network 104 for storage and use in communications with the authenticated user equipment 102 and access network 104 informs user equipment 102 about the successful authentication with the EAP Success message.

If in step 2100 AAA server 108 determines that the information is not the same as the ongoing session, AAA server 108 considers that the authentication exchange is related to a new session of a network that is illustrated in FIG. 2. An AAA server that is associated with the old session may then be instructed to terminate the old session based on whether simultaneous sessions are allowed or whether the number of allowed sessions has been exceeded.

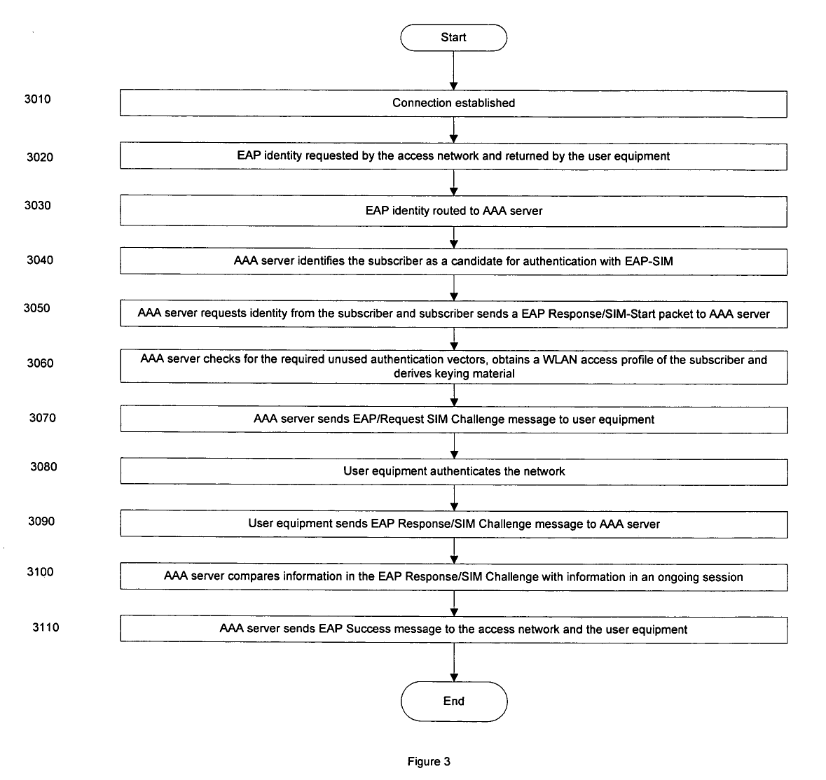

FIG. 3 illustrates the steps implemented to use the EAP-SIM based authentication mechanism in WLAN-3GPP interworking. As shown in FIG. 3, EAP-SIM authentication mechanism can be implemented without the need for a UICC with a USIM application. In Step 3010, a connection is established between user equipment 102 and access network 104, using a wireless LAN technology. In Step 3020, access network 104 sends an EAP Request/Identity to user equipment 102 and user equipment 102 sends an EAP Response/Identity message with an identity of user equipment 102 to access network 104. The identity complies with the network access identifier (NAI) format and includes either a temporary identifier allocated to user equipment 102 in a previous authentication, or in a case of a first authentication with the network, the IMSI. In Step 3030, the message is routed towards the proper AAA server based on a realm part of the NAI. The routing path may include one or several AAA proxies. In Step 3040, AAA server 108 receives the EAP Response/Identity packet that includes the subscriber identity and the identifier of the WLAN network, among other information, and identifies the subscriber as a candidate for authentication with EAP-SIM, based on the received identity and sends an EAP Request/SIM-Start packet to user equipment 102.

In Step 3050, AAA server 108 requests the user identity using a EAP Request/SIM-Start packet and user equipment chooses a fresh randon number, NONCE_MT, that is used in network authentication and responds with a EAP Response/SIM-Start packet that includes the same identity user equipment 102 used in the EAP Response/Identity message and NONCE_MT. Access network 104 forwards the EAP Response/SIM-Start packet to AAA server 108 for use by AAA server 108 in the authentication process. In Step 3060, AAA server 108 checks that it has available N unused authentication vectors for the subscriber, obtains the WLAN access profile of the subscriber and verifies that the subscriber is authorized to use the WLAN service. AAA server 108 also derives keying material from NONCE_MT keys, among other keys, and a new pseudonym may be chosen and protected using EAP-SIM generated keying material. In Step 3070, AAA server 108 sends RAND, AUTH, a message authentication code (MAC) and the user identities (protected pseudonym and/or re-authentication ID), if generated, to user equipment 102 in a EAP Request/SIM Challenge message. User equipment 102 runs N time the GSM A3/A8 algorithms in the SIM, once for each received RAND and derives N SREC and Kc values. User equipment 102 also derives additional keying material from the N Kc keys and NONCE_MT, calculates a copy of the network authentication MAC with the newly derived keying material and checks that it is equal with the received MAC, in Step 3080. User equipment 102 continues the authentication exchange only if the MAC is correct. In Step 3090, user equipment calculates a new MAC value covering the EAP message with the new keying material and sends the EAP Response/SIM-Challenge containing the newly calculated MAC value to AAA server 108. In Step 3100, AAA server 108 checks and compares the received information with the same information of the ongoing session and if the information is the same as the ongoing session, AAA server determines that the authentication exchange is related to the ongoing session. In Step 3110, AAA server 108 then sends a EAP Success message and additional keying material to access network 104 for storage and use in communications with the authenticated user equipment 102 and access network 104 informs user equipment 102 about the successful authentication with the EAP Success message.

If in step 3100 AAA server 108 determines that the information is not the same as the ongoing session, AAA server 108 considers that the authentication exchange is related to a new session of a network that is illustrated in FIG. 2. An AAA server that is associated with the old session may then be instructed to terminate the old session based on whether simultaneous sessions are allowed or whether the number of allowed sessions has been exceeded.

When user equipment 102 is attempting to authenticate within WLAN access, user equipment 102 derives the home network domain name/NAI from the International Mobile Subscriber Identity (IMSI). The IMSI includes a mobile country code (MCC) for uniquely identifying the country of domicile of a mobile subscriber and a mobile network code (MNC) for identifying the home. PLMN of the mobile subscriber. Specifically, user equipment 102 takes up to the first 6 digits of the IMSI, depending on whether a 2 or 3 digit MNC is used and allocates the first 3 digits to the MCC and the next 2 or 3 digits to the MNC. According to the inventive system, the identity of user equipment 102 in the EAP Response/Identity message includes an enhanced NAI format that also includes WLAN scenario information and possible visited network information. Specifically, one example of the enhanced NAI format is:

wlan<SCEN>.vmnc<VMNC>.vmcc<VMCC>.mnc<MCN>.mcc<MCC>.3gppnetwork.org

where:

wlan<SCEN> identifies the WLAN scenario. For example, the network scenario illustrated in FIG. 1a is identified as “wlan-scen2”; the network scenario illustrated in FIG. 1b is identified as “wlan-scen3-hn” if the user equipment is requesting access to the home network; and the network scenario illustrated in FIG. 1c is identified as “wlan-scen3-vn” if the user equipment is requesting access to the visited network;

vmnc<VMNC> and vmcc<VMCC> identify the visited network mobile network code and mobile country code; and

mnc<MNC> and mcc<MCC> identify the home network mobile network code and mobile country code.

Note that if the user equipment is not accessing a visited network, the section for the visited network may be omitted. So if, for example, the IMSI in use is 234150999999999, where the MCC is 234 and the MNC is 15 and if the user equipment is in a network scenario as illustrated by FIG. 1a, then the NAI would be: wlan.wlan-scen2.mnc15.mcc234.gppnetwork.org.

By using the enhanced NAI format during authentication, even though an impostor/malicious visited network packet data gateway and/or a malicious WLAN access network can modify a NAI in the EAP Response/Identity message, the malicious visited network packet data gateway and/or the malicious WLAN access network cannot modify the same NAI when the AAA server again requests the user identity using the EAP Request/AKA Identity message or the EAP Request/SIM-Start message, depending on the authentication method used. Furthermore, if the malicious visited network packet data gateway and/or the malicious WLAN access network does not modify the NAI, but instead pretends to be a different network element, the AAA server will notice that the request came from the wrong source based on the received NAI.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A user equipment for accessing at least one of wireless local area network interworking services and third generation partnership project network services, the user equipment comprising;
receiving means for receiving third generation partnership project network services from at least one third generation partnership project network and for receiving wireless local area network interworking services from an access network that connects the user equipment to the third generation partnership project network; and
generating means for generating, during network authentication, a network access identifier comprising wireless local area network scenario information,
wherein an impostor is prevented from modifying the network access identifier during a response from the user equipment to the at least one third generation partnership project network implementing an authentication mechanism.

2. The user equipment of claim 1, wherein the network access identifier comprising wireless local area network scenario information is used in a EAP-AKA authentication mechanism.

3. The user equipment of claim 1, wherein the network access identifier comprising wireless local area network scenario information is used in a EAP-SIM authentication mechanism.

4. The user equipment of claim 1, wherein the network access identifier is used for notifying a server on the at least one third generation partnership project network about a source that generated the network access identifier.

5. The user equipment of claim 1, wherein the network access identifier comprises at least one field for identifying a wireless local area network scenario and at least one field for identifying a home network, the at least one field for identifying a home network comprises a mobile country code and a mobile network code associated with the home,

6. The user equipment of claim 5, wherein the network access identifier further comprises at least one field for identifying a visited network.

7. A server for using a network access identifier to identify a user equipment during network authentication between the user equipment and a third generation partnership project network, the server comprising:
receiving means for receiving the network access identifier from the user equipment; and
requesting means for requesting the network access identifier using an authentication mechanism,
wherein the network access identifier includes at least one field for identifying a wireless local area network scenario and at least one field for identifying a home network, the at least one field for identifying a home network comprises a mobile country code and a mobile network code associated with the home, and
wherein by requesting the network access identifier in an authentication mechanism an impostor is prevented from modifying the network access identifier during a response from the user equipment to the at least one third generation partnership project network implementing the authentication mechanism.

8. The server of claim 7, wherein the at least one field for identifying a wireless local area network scenario comprises information for identifying a first scenario whereby the user equipment is connected to the third generation partnership project network via the wireless local area network access point.

9. The server of claim 7, wherein the at least one field for identifying a wireless local area network scenario comprises information for identifying a second scenario whereby the user equipment is connected to a visited third generation partnership project network and a home third generation partnership project network via the wireless local area network access point, and wherein the home third generation partnership project network is responsible for tunnel establishment.

10. The server of claim 7, wherein the at least one field for identifying a wireless local area network scenario comprises information for identifying a third scenario whereby the user equipment is connected to a visited third generation partnership project network and a home third generation partnership project network via the wireless local area network access point, and wherein the visited third generation partnership project network is responsible for tunnel establishment.

11. The server of claim 7 further comprising at least one field for identifying a visited network, wherein the at least one field for identifying a visited network includes a mobile country code and a mobile network code associated with the visited network.

12. A server for using a network access identifier to identify a user equipment during network authentication between the user equipment and a third generation partnership project network, the server comprising:
receiving means for receiving the network access identifier from the user equipment; and
requesting means for requesting the network access identifier using an authentication mechanism,
wherein the network access identifier includes at least one field for identifying a wireless local area network scenario, at least one field for identifying a home network, the at least one field for identifying a home network comprises a mobile country code and a mobile network code associated with the home and at least one field for identifying a home network, the at least one field for identifying a home network including a mobile country code and a mobile network code associated with the home, and
wherein by requesting the network access identifier in an authentication mechanism an impostor is prevented from modifying the network access identifier during a response from the user equipment to the at least one third generation partnership project network implementing the authentication mechanism.

13. A method for identifying a user equipment during network authentication between the user equipment and a third generation partnership project network, the method comprising the steps of:
establishing a connection between the user equipment and the third generation partnership project network through a wireless local area network access point;
providing a user equipment identity, by the user equipment, wherein the user equipment identity comprises a network access identifier having at least one field for identifying a wireless local area network scenario;
receiving, by the user equipment, a request for the user equipment identity with an authentication mechanism request message;
resubmitting, by the user equipment, the network access identifier in an authentication mechanism response message, wherein an impostor unable to modify the resubmitted network access identifier in the authentication mechanism response message.

14. The method of claim 13, wherein the step of resubmitting comprises sending the network access identifier in an EAP Response/Identity message.

15. The method of claim 13, wherein the step of resubmitting comprises sending the network access identifier in an EAP Response/SIM-Start message.

16. A apparatus for identifying a user equipment during network authentication between the user equipment and a third generation partnership project network, the apparatus comprising:
establishing means for establishing a connection between the user equipment and the third generation partnership project network through a wireless local area network access point;
providing means for providing a user equipment identity, by the user equipment, wherein the user equipment identity comprises a network access identifier comprising at least one field for identifying a wireless local area network scenario;
receiving means for receiving, by the user equipment, a request for the user equipment identity with an authentication mechanism request message;
means for resubmitting, by the user equipment, the network access identifier in an authentication mechanism response message, wherein an impostor unable to modify the resubmitted network access identifier in the authentication mechanism response message.
